(19) United States
(12) Patent Application Publication
(10) Pub. No.: US 2005/0222359 A1
(43) Pub. Date: Oct. 6, 2005

(54) Method of manufacturing organic polysilane

(75) Inventors: Hideaki Machida, Yamanashi (JP); Chuan Xin Liang, Yamanashi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Tri Chemical Laboratories Inc., Kitatsuru-Gun (JP)

(21) Appl. No.: 11/058,288

(22) Filed: Feb. 16, 2005

(30) Foreign Application Priority Data
Mar. 30, 2004 (JP) 2004-097976

(51) Int. Cl. C08G 77/06

(52) U.S. Cl. 528/14

(57) ABSTRACT

A technique capable of synthesizing organic polysilane having a high molecular weight at an excellent yield and simply even without employing a catalyst such as a copper halide is provided. In a method of manufacturing the organic polysilane by reacting dialkyldihalosilane with alkali metal, said reaction is carried out in THF.

### BACKGROUND OF THE INVENTION

The present invention relates to organic polysilane, and more particularly to a method of manufacturing organic polysilane of which a molecular weight is 20000 or more, and to a film and an optical waveguide prepared by employing said organic polysilane.

In recent years, the organic polysilane has received much attention as a material for an optical waveguide because it has the property that a refractive index is changed with photo-irradiation. Transmission loss of light, however, is heavy in the organic polysilane of which a polymerization degree is low. Accordingly, the organic polysilane having a high polymerization degree has been requested.

Hitherto, several methods of manufacturing the organic polysilane have been proposed.

For example, in JP-P1992-185642A, as to a method of manufacturing the organic polysilane by reacting dihalosilane represented with R₁(R₂)SiX₂, where R₁ or R₂ is H or an alkyl group and X is halogen, in an inactive solvent in the presence of alkali metal, the method was disclosed of manufacturing the organic polysilane for reacting said dihalosilane at 100° C. or more and yet at a temperature equal to or less than a boiling point of said inactive solvent with a copper halide assumed to be a catalyst.

Herein, hydrocarbons such as toluene, xylene, decane, and decalin were listed as an inactive solvent. However, there exists no disclosure suggesting other types of chemical compounds.

In the same publication, there exists the following disclosure in the column of the embodiment of the invention.

4.8 g of fine particles of metallic sodium and 60 g of xylene were poured into a four-necked flask. And, it was heated/stirred at 138° C. to form a sodium dispersion. Thereafter, 0.019 g of CuI was added hereto. And, with a reaction temperature set at 132° C., 19.1 g of phenylmethyldichlorosilane was added drop-wise while it was heated/stirred. The reaction progressed exothermically, and the solution was tinged with purple. After heating/agitating for six hours, the sodium almost vanished. And, the temperature of the reaction solution was returned to a room temperature to finish the reaction. Approx. 5 ml. of methanol was added to the reaction solution to deactivate the metallic sodium. Thereafter, so as to dissolve/decompose a sodium chloride produced in the process of the above-mentioned exothermal reaction with approx. 100 ml. of water, washing with water was carried out several times. Next, after an organic layer was taken out and condensed, a fractional precipitation was made for a toluene/acetone system. As a result, the polysilane of which a molecular weight was 1020000 was obtained at a yield of 15%.

On the other hand, the polysilane was manufactured in a method similar to the foregoing with the exception that no copper halide (CuI) was added. The molecular weight of the polysilane obtained by this was 100000, and its yield was 10%.

Judging from this, it was clearly stated that the polysilane having a high molecular weight was not obtained at an excellent yield in a case where no copper halide (Cu I) was employed in reacting the dihalosilane with the alkali metal.

Also, in JP-P1999-263845A was disclosed a method of manufacturing the polycilane comprising the steps of: obtaining an alkali metal dispersion by adding a copper compound, an ether compound, and alkali metal to a solvent accompanied by heating; obtaining a reactant by adding a halosilane compound, which was dissolved in the solvent, to this dispersion drop-wise; and adding trimethylsilane, which was dissolved in the solvent, to said reactant for further reaction.

Herein, a copper halide similar to the copper halide employed in JP-P1992-185642A was listed as a copper compound, and copper acetate, copper acetylacetate, a copper cyanide, and what not were listed in addition hereto. As a solvent were listed nonpolar solvents, for example, hexane, heptane, octane, toluene, xylene, cyclohexane, cumene, ethylbenzene, and mixed solvents thereof. As an ether compound were listed crown ether and its derivatives, ethylene glycol derivatives such as tetrahydrofuran and diglyme, dioxane, tetraoxane, cryptand, etc.

In the same publication, there exists the following disclosure in the column of the embodiment of the invention.

A mixed solvent of 136 ml. of absolute toluene and 24 ml. of absolute heptane were poured into the four-necked flask provided with a dropping funnel and a reflux condenser. 0.50 g of a copper (I) chloride, 13.26 g (0.0602 mol) of 15-crown-5-ether, and 27.6 g (1.20 mol) of metallic sodium were added to this mixed solvent. And, it was heated up to a solvent reflux temperature in an atmosphere of argon to regulate a sodium dispersion. With this dispersion maintained at the solvent reflux temperature, 58.53 g (0.500 mol) of methyldichlorosilane dissolved in the mixed solvent of 34 ml. of absolute toluene and 6 ml. of absolute heptane were added to the forgoing dispersion drop-wise from the drooping funnel over approx. 30 minutes. And, it was reacted at the solvent reflux temperature for 3 hours. Next, 10.8 g (0.10 mol) of trimethylchlorosilane dissolved in 20 ml. of absolute toluene was added hereto to further react it for two hours. Thereafter, the reaction solution was cooled to a room temperature. 500 ml. of toluene was added to the reaction solution after cooling. And, pressure filtration was made for the produced precipitate at the presence of nitrogen. Next, the obtained filtrate was condensed. 500 ml. of ethanol was added to this solution to precipitate a polymer. After this obtained polymer was filtered, it was dissolved in toluene. And, the obtained solution was cleansed with ion-exchanged water. Next, it was dried with anhydrous magnesium sulfate. After the drying agent was removed, the solvent was removed under a reduced pressure. And, it was dissolved by adding 100 ml. of toluene, and this toluene solution was added to 1000 ml. of ethanol drop-wise. Finally, the precipitate was filtered and dried. As a result, 6.56 g (29.7%) of the solid organic polysilane tinged with light yellow was obtained. Additionally, a weight-average molecular weight of this organic polysilane was 5000.

The problem with this existed in a case where the following was done. 160 ml. of absolute toluene was poured into the four-necked flask provided with the dropping funnel and the reflux condenser. 0.50 g of a copper (I) chloride and 27.6 g (1.20 mol) of metallic sodium were added to this solvent. And, it was heated up to the solvent reflux temperature in an atmosphere of argon to regulate a sodium dispersion. With this dispersion maintained at the solvent reflux temperature, 58.53 g (0.500 mol) of methyldichlorosilane dissolved in 40 ml. of absolute toluene was added to the forgoing dispersion drop-wise from the drooping funnel over approx. 30 minutes. And, it was reacted at the solvent reflux temperature for 3 hours. Next, 10.8 g (0.10 mol) of trimethylchlorosilane dissolved in 20 ml. of absolute toluene was added hereto to further react it for two hours. Thereafter, the reaction solution was cooled to the room temperature. 500 ml. of toluene was added to the reaction solution after cooling. And, pressure filtration was made for the produced precipitate at the presence of nitrogen. Next, the obtained filtrate was condensed. 500 ml. of ethanol was added to this solution. No polymer, however, was precipitated. Thereupon, the mixed solution was condensed to re-precipitate the polymer with methanol. After the obtained polymer was filtered, it was dissolved in toluene. This obtained solution was cleansed with ion-exchanged water, and then, was dried with anhydrous magnesium sulfate. After the drying agent was removed, the solvent was removed under a reduced pressure. And, it was dissolved by adding 50 ml. of toluene. This toluene solution was added to 500 ml. of methanol drop-wise; however the precipitate was obtained only in extremely small quantities.

A mixed solvent of 136 ml. of absolute toluene and 24 ml. of absolute heptane were poured into the four-necked flask provided with the dropping funnel and the reflux condenser. 13.26 g (0.060 mol) of 15-crown-5-ether and 27.6 g (1.20 mol) of metallic sodium were added to this mixed solvent. And, it was heated up to the solvent reflux temperature in an atmosphere of argon to regulate a sodium dispersion. With this dispersion maintained at the solvent reflux temperature, 58.53 g (0.500 mol) of methyldichlorosilane dissolved in the mixed solvent of 34 ml. of absolute toluene and 6 ml. of absolute heptane were added to the forgoing dispersion drop-wise from the dropping funnel over approx. 30 minutes. And, it was reacted at the solvent reflux temperature for 3 hours. Next, 10.8 g (0.10 mol) of trimethylchlorosilane dissolved in 20 ml. of absolute toluene was added hereto to further react it for two hours. Thereafter, the reaction solution was cooled to the room temperature. 500 ml. of toluene was added to the reaction solution after cooling. And, pressure filtration was made for the produced precipitate at the presence of nitrogen. Next, the obtained filtrate was condensed. 500 ml. of ethanol was added to this solution to precipitate a polymer. After this obtained polymer was filtered, it was dissolved in toluene. And, the obtained solution was cleansed with ion-exchanged water. Next, it was dried with anhydrous magnesium sulfate. After the drying agent was removed, the solvent was removed under a reduced pressure. And, it was dissolved by adding 100 ml. of toluene, and this toluene solution was added to 1000 ml. of ethanol drop-wise. Finally, the precipitate was filtered and dried. As a result, 1.61 g (7.3%) of the polymer was obtained. The weight-average molecular weight of this organic polysilane was 2000.

Judging from this result, it was clearly stated that unless crown ether as an ether compound exists, the effect of having added the copper compound was not obtained in polymerizing the dihalosilane monomer having an Si—H linkage of which reactivity was high.

Also, it was clearly stated that also in a case where the crown ether was added, unless the copper compound existed, the weight-average molecular weight of the obtained polysilane, which was 2000 or something like it, was low, and further, the yield, which was 7%, was also low.
[Patent document 1] JP-P1992-185642A
[Patent document 1] JP-P1999-263845A

### SUMMARY OF THE INVENTION

By the way, the methods of manufacturing the organic polysilane disclosed in the above-mentioned publications are not so simple. For example, the catalyst such as the copper halide is required in addition to the dihalosilane and the alkali metal that act as a raw material. Also, as the case may be, the reaction temperature is high. Thus, the manufacturing cost becomes high.

Therefore, the problem to be solved by the present invention is to provide a technique capable of synthesizing the organic polysilane having a high molecular weight simply, yet at a low cost, and further at an excellent yield without employing the catalyst such as the copper halide.

The present inventor et al. aggressively made a research on a technique of synthesizing the organic polysilane having a high molecular weight without employing the catalyst such as the copper halide. As a result, they found out that it was possible to synthesize the organic polysilane having a high molecular weight at an excellent yield even without employing the copper halide in a case where a solvent was employed for reaction and tetrahydrofuran was employed as a solvent.

By the way, in the technique up to this time point, it has been believed that the catalyst such as the copper halide is absolutely essential for synthesizing the organic polysilane having a high molecular weight at an excellent yield.

On the other hand, it can be safely said that the present invention that does dispense with the catalyst such as the copper halide is epochal.

And, it was also grasped that the transmission loss of light in a film prepared by employing the organic polysilane obtained in the embodiment of the present invention was low as compared with the transmission loss of light in the film prepared by employing the organic polysilane obtained in the conventional synthesizing technique.

That is, in order to solve the above-mentioned problems, a method is applied of manufacturing the organic polysilane having a reaction step of reacting dihalosilane with alkali metal, wherein said reaction is carried out in a solvent represented with the following general formula [I].

The present invention provides an organic polysilane film prepared by employing the organic polysilane manufactured in a reaction step of reacting dihalosilane with alkali metal, said reaction being carried out in a solvent represented with the following general formula [I].

Moreover, the present invention provides an optical waveguide prepared by employing organic polysilane manufactured in a reaction step of reacting dihalosilane with alkali metal, said reaction being carried out in a solvent represented with the following general formula [I], wherein radiating light onto a film of said organic polysilane causes a refractive index of one part thereof to be changed:
General formula [I] 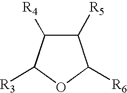
where R₃, R₄, R₅, or R₆ is H or an alkyl group, each which has the same type or a different type.

In the present invention mentioned above, said reaction is carried out by adding said dihalosilane to a solution containing said alkali metal and a chemical compound represented with said general formula [I]. In particular, said reaction was carried out by adding said dihalosilane to a solution containing said alkali metal and a chemical compound represented with said general formula [I], of which the temperature is 30° C.-70° C.

The present invention mentioned above has an extraction step of, after said reaction step, extracting the organic polysilane. This extraction is carried out, particularly, by employing toluene.

The present invention mentioned above has a purification step. This purification step is for purifying said extracted organic polysilane by precipitating it again.

The present invention mentioned above has a deactivation step. This deactivation step is for deactivate the alkali metal, which still remains in said reaction solution, after said reaction step and yet before said extraction step.

In the present invention mentioned above, there is no possibility that a copper compound selected from the group consisting of a copper halide, copper acetate, copper acetylacetate, and a copper cyanide is employed as a catalyst.

The dihalosilane to be employed in the present invention is a chemical compound (dialkyldihalosilane) represented with R₁(R₂)Si(X₁)X₂, where R₁ or R₂ is H or an alkyl group, each which has the same type or a different type, and X₁ or X₂ is halogen (F, Cl, Br, or I), each which has the same type or a different type. Preferably, it is phenylmethyldichlorosilane.

The solvent to be employed in the present invention is a chemical compound represented with the above-mentioned general formula [I], where R₃, R₄, R₅, or R₆ is H or an alkyl group. (Preferably, an alkyl group having a carbon number of 1 to 4. (Particularly, 1 or 2)). Preferably, it is tetrahydrofuran (THF).

The alkali metal to be employed in the present invention is Na, K, etc. Most preferably, it is Na.

Additionally, in said JP-P1999-263845A, there exists the disclosure that a copper compound, an ether compound, and alkali metal are added to the solvent to obtain an alkali metal dispersion by heating, a halosilane compound dissolved in the solvent is added to this dispersion drop-wise to obtain a reactant, and trimethylsilane dissolved in the solvent is added to this reactant for further reaction.

Also, there exists the disclosure with regard to tetrahydrofuran as a general description of the ether compound.

Judging from such a fact, it may be imagined that it can be thought that the copper compound, the tetrahudrofuran, and the alkali metal are added to the solvent (However, there is no disclosure suggesting that this solvent is tetrahydrofuran.) to obtain an alkali metal dispersion by heating, the halosilane compound dissolved in the solvent is added to this dispersion drop-wise to obtain a reactant, and the trimethylsilane dissolved in the solvent is added to this reactant for further reaction.

In the embodiment of JP-P1999-263845A having the best mode of the invention disclosed, however, there exists no example having the ether compound employed, yet there exists no example having the tetrahydrofuran employed as a solvent, and further, there is no description suggesting that a mention was made of obviating the necessity of employing the copper compound.

Moreover, in JP-P1999-263845A, it was clearly stated that unless three parties of the copper compound, the crown ether compound, and the alkali metal existed, the organic polysilane having a high polymerization degree was impossible to obtain.

Accordingly, it is definitely impossible to believe that JP-P1999-263845A implies the present invention.

In accordance with the present invention, the organic polysilane of which the weight-average molecular weight is, for example, 20000 or more (in particular, the weight-average molecular weight is 25000 or more, further 30000 or more) can be synthesized simply, yet at an inexpensive cost, and at an excellent yield.

For example, conventionally, it has been said that unless the catalyst such as the copper halide is employed, the organic polysilane having a high molecular weight is impossible to synthesize at an excellent yield. However, it is very epochal that the organic polysilane having a high molecular weight can be synthesized even without employing such a catalyst.

The optical waveguide, wherein light is radiated onto the organic polysilane film prepared by employing the organic polysilane obtained in the above-mentioned method of manufacturing the organic polysilane and this photo-irradiation causes a refractive index of one part thereof to be changed, is very excellent in the transmission characteristic of light.

### BRIEF DESCRIPTION OF THE DRAWING

This and other objects, features and advantages of the present invention will become apparent upon a reading of the following detailed description and a drawing, in which:

FIG. 1 is a schematic sectional diagram illustrating a waveguide.

### DESCRIPTION OF THE EMBODIMENTS

The method of manufacturing the organic polysilane in accordance with the present invention is a method of manufacturing the organic polysilane by reacting dihalosilane with alkali metal. Particularly, it is a method of manufacturing the organic polysilane by reacting dihalosilane with alkali metal without employing copper compounds such as copper halides, copper acetate, copper acetylacetate, or a copper cyanide as a catalyst. Said reaction is carried out in a solvent represented with the above-mentioned general formula [I]. Said reaction is carried out by adding dihalosilane to a solution containing said alkali metal and a chemical compound (solvent) represented with said general formula [I]. In particular, it is carried out by adding dihalosilane to a solution containing said alkali metal and a chemical compound (solvent) represented with the above-mentioned general formula [I], of which the temperature is 30° C.-70° C. (Particularly, 35° C. or more and yet 67° C. or less. Moreover, 65° C. or less). The organic polysilane is extracted with toluene after the reaction between the dihalosilane and the alkali metal. Also, said extracted organic polysilane is precipitated again and purified. Also, the alkali metal that still remains in said reaction solution is deactivated, by adding, for example, toluene, methanol, water and a hydrochloric acid after said reaction and yet before said extraction.

The dihalosilane to be employed in the present invention is a chemical compound (dialkyldihalosilane) represented with R₁(R₂)Si(X₁)X₂, where R₁ or R₂ is H or an alkyl group (Preferably, a carbon number is 1 to 15. Particularly, 1 or more. 12 or less. Moreover, 10 or less), each which has the same type or a different type, and X1 or X₂ is halogen such as Cl, each which has the same type or a different type. Particularly, it is phenylmethyldichlorosilane.

The solvent to be employed in the present invention is a chemical compound represented with the above-mentioned general formula, where R₃, R₄, R₅, or R₆ is H or an alkyl group (Preferably, an alkyl group having a carbon number of 1 to 4 (Particular, 1 or 2)). Particularly, it is tetrahydrofuran.

The alkali metal to be employed in the present invention is Na, K, etc. Particularly, it is Na.

And, the organic polysilane film is prepared by employing the organic polysilane obtained in the above-mentioned manner.

Also, the optical waveguide is obtained, by radiating light onto the organic polysilane obtained in the above-mentioned manner to change the refractive index of one part thereof.

Specific embodiments will be described below.

### Embodiment

[Synthesis of Organic Polysilane of which a Molecular Weight is 20000 or More]

At first, tetrahydrofuran (THF) and sodium (Na) were poured into a reaction container in an atmosphere of argon (Ar). And, the reaction container was heated to 50° C. Phenymethyldichlorosilane was slowly added to this Na-THF solution (THF is a solvent) drop-wise. This dropping caused the reaction to be initiated. And, the reaction solution generated heat so that its temperature became 85° C. or something like it. After stirring for several hours, toluene, methanol, water, and a hydrochloric acid were added in its order to deactivate the excessive sodium. And, after extracting an organic component with toluene, a re-precipitation was made with methanol. Further, the second re-precipitation was made with isopropanol. This allows the target organic polysilane to be obtained.

The molecular weight of the obtained organic polysilane was measured with a gel permeation chromatograph. Its result demonstrated that the weight-average molecular weight was 20000 to 35000. The yield was 50% to 70%. [Synthesis of Prganic Polysilane by Employing other Solvents

### COMPARATIVE EXAMPLES

The comparative examples were carried out similarly to the above-mentioned embodiment with exception that xylene, diglyme, dibutyl ether, or toluene is employed instead of THF.

The molecular weight of the organic polysilane obtained in this method was measured. Its result was shown in the following table-1.

TABLE 1

| | weight-average molecular weight of |
|---|---|
| Solvent | organic polysilane |
| xylene | 5600 |
| diglyme | 6600 |
| dibutyl ether | 6700 |
| toluene | 3900 |

Also, the organic polysilane was synthesized by employing the toluene as a solvent and yet the catalyst (CuCl), and by means of the technique disclosed in JP-P1992-185642A. Also in this case that became a comparative example, the weight-average molecular weight of the obtained organic polysilane was 8300 or something like it.

That is, in accordance with the present invention, the organic polysilane having a high polymerization degree can be obtained efficiently and simply. [Preparation of a Thin Film of the Organic Polysilane]

A 50% xylene solution of the organic polysilane synthesized in the above-mentioned embodiment was coated on a silicon substrate twice with a spin coating method (at a speed of 3000 rpm for 30 seconds). Thereafter, it was maintained at 130° C. for one hour to prepare a thin film by removing the solvent.

The film obtained in such a manner was 4 μm in thickness, and its surface was uniform.

This thin film was heat-treated at a temperature of 200° C.-250° C. And, the transmission loss of light (a wavelength: 1550 nm) was investigated. As a result, the transmission loss was low (0.07 dB/cm).

[Preparation of a Waveguide]

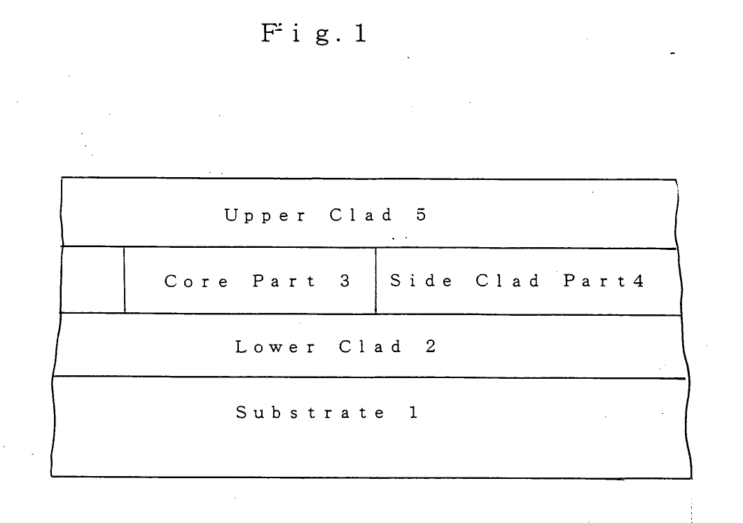

A lower clad layer was formed on a substrate, and next, a thin film of the organic polysilane obtained in the above-mentioned embodiment was prepared with the spin coating method. And, ultra-violet light having an intensity of 60 mW/cm² was radiated onto a part assumed to be a core to make a patterning thereof. Continuously, an upper clad layer was formed to prepare a waveguide as shown in FIG. 1.

This waveguide has a 5% difference of the refractive index between the ultra-violet light radiation part (core part) and the non-radiation part (side clad part). And, it was an excellent waveguide having a sharp boundary in which no light leaked.

1 A method of manufacturing organic polysilane, said method comprising a reaction step of reacting dihalosilane with alkali metal, wherein said reaction is carried out in a solvent represented with the following general formula [I].
General formula [I]: 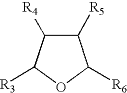
where R₃, R₄, R₅, or R₆ is H or an alkyl group, each which has the same type or a different type.

2 The method of manufacturing the organic polysilane as claimed in claim 1, wherein said reaction is carried out by adding said dihalosilane to a solution containing said alkali metal and a chemical compound represented with said general formula [I].

3 The method of manufacturing the organic polysilane as claimed in claim 1, wherein said reaction is carried out by adding said dihalosilane to a solution containing said alkali metal and a chemical compound represented with said general formula [I], of which a temperature is 30° C.-70° C.

4 The method of manufacturing the organic polysilane as claimed in claim 1, comprising an extraction step of, after said reaction step, extracting the organic polysilane.

5 The method of manufacturing the organic polysilane as claimed in claim 4, wherein said extraction of said organic polysilane is carried out with toluene.

6 The method of manufacturing the organic polysilane as claimed in claim 4, comprising a purification step of purifying said extracted organic polysilane by precipitating it again.

7 The method of manufacturing the organic polysilane as claimed in claim 4, comprising a deactivation step of, after said reaction step and yet before said extraction step, deactivating said alkali metal that still remains in said reaction solution.

8 The method of manufacturing the organic polysilane as claimed in claim 1, wherein said dihalosilane is dialkyldihalosilane represented with R₁(R₂)Si(X₁)X₂, where R₁ or R₂ is H or an alkyl group, each which has the same type or a different type, and X₁ or X₂ is halogen, each which has the same type or a different type.

9 The method of manufacturing the organic polysilane as claimed in claim 1, wherein said dihalosilane is phenylmethyldichlorosilane.

10 The method of manufacturing the organic polysilane as claimed in claim 1, wherein said solvent is tetrahydrofuran.

11 The method of manufacturing the organic polysilane as claimed in claim 1, wherein said alkali metal is sodium.

12 The method of manufacturing the organic polysilane as claimed in claim 1, wherein the organic polysilane of which a molecular weight is 20000 or more is manufactured.

13 The method of manufacturing the organic polysilane as claimed in claim 1, wherein a copper compound selected from the group consisting of a copper halide, copper acetate, copper acetylacetate, and a copper cyanide is not employed.
